(19) United States
(12) Patent Application Publication
(10) Pub. No.: US 2009/0051966 A1
(43) Pub. Date: Feb. 26, 2009

(54) Printing system and printing method

(75) Inventors: Masafumi Okigami, Nara (JP); Ritsuko Matsumoto, Kyoto (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/229,358

(22) Filed: Aug. 22, 2008

(30) Foreign Application Priority Data
Aug. 24, 2007 (JP) 2007-218929

(51) Int. Cl. G06F 3/12

(52) U.S. Cl. 358/1.15

(57) ABSTRACT

In a client PC, a print object permitted to be printed is specified for each MFP among the created distribution materials, a correspondence table between the object and an ID for identifying an MFP permitted to print the object is prepared, and the distribution materials and the correspondence table are transmitted to a print server. When the MFP transmits a print request and an ID assigned to the MFP to the print server, the print server transmits to the MFP a print object corresponding to the transmitted ID upon receiving the print request. The MFP receives and outputs the object.

### CROSS-REFERENCE TO RELATED APPLICATION

This application claims priority to Japanese Patent Application No. 2007-218929, which was filed on Aug. 24, 2007, the contents of which are incorporated herein by reference in its entirety.

### BACKGROUND OF THE INVENTION

1. Field of the Invention

The present invention relates to a printing system and a printing method in which a print server device manages electronic data generated by a client device is managed by a print server device and a plurality of printing devices receive electronic data managed by the print server and directly prints the electronic data managed by the print server device.

2. Description of the Related Art

Recently a plurality of shops and a management department or shop thereof are usually connected in a network for communication therebetween, and in the case where a necessity of distributing materials to the plurality of shops occurs, for example, in the case where a person in charge of material distribution who belongs to the management department distributes materials to the plurality of shops, the materials are distributed in a manner that the electronic data of materials distributed to a responsible person of each of the plurality of shops is transmitted as an attachment to an electronic mail addressed to the responsible person, and the attached data is received and opened by the responsible person of the each shop, followed by being printed using a printer.

In such a case, it is possible that to-be-disclosed part of the transmitted distribution materials changes from shop to shop, and in a circumstance like that, the person in charge of material distribution is required to perform, for each of the shop, an editing operation of keeping to-be-disclosed part of the distribution materials left and delete the rest so that only the part to be disclosed to a shop is transmitted the shop, for example. Therefore, the person in charge of distribution has to perform a very complicated task.

In a printing system of Japanese Unexamined Patent Publication JP-A 2005-222224, users register a document file from a client terminal to a document managing server. Further, for a print server, the users specify a print range of the registered document file and make a print request.

In the printing system of JP-A 2005-222224, a responsible person of each of a plurality of shops is required to pre-understand a print range in materials distributed to him, and a person in charge of distribution is required to separately inform each of the responsible persons of the print range. The task of the person in charge of distribution is not simplified. Further, the printing system of JP-A 2005-222224 fails to work well when not all the distribution materials are open to the shops.

### SUMMARY OF THE INVENTION

An object of the present invention is to provide a printing system and a printing method capable of simplifying a task of a person in charge of distribution in preparing distribution materials and capable of disclosing to each of shops the distribution materials only to an extent that is permitted to be printed.

The invention provides a printing system comprising:

a client device for generating electronic data;

a print server device for managing the electronic data generated by the client device; and

a plurality of printing devices for acquiring and directly printing the electronic data managed by the print server device, data communication being allowed thereamong,

the client device specifying a printable part of the generated electronic data for each of the plurality of printing devices, preparing a correspondence table in which the printable part of the generated electronic data for each of the plurality of printing devices is correlated with a key for identifying a printing device which is permitted to print the printable part of the generated electronic data, and transmitting the generated electronic data and the correspondence table to the print server device,

the print server device receiving and managing the electronic data and the correspondence table transmitted from the client device,

the printing device transmitting a print request and the key assigned to the printing device, to the print server device, and

upon receiving the print request, the print server device transmitting to the printing device the part of electronic data corresponding to the transmitted key, and the printing device acquiring and outputting the part of electronic data.

According to the invention, a printing system comprises a client device; a print server device; and a plurality of printing devices, which are configured so that data communication is allowed thereamong.

Firstly, the client device specifies a printable part of the generated electronic data for each of the plurality of printing devices, prepares a correspondence table in which the printable part of the generated electronic data for each of the plurality of printing devices is correlated with a key for identifying a printing device which is permitted to print the printable part of the generated electronic data, and transmits the generated electronic data and the correspondence table to the print server device.

The print server device stores and manages the electronic data and the correspondence table transmitted from the client device.

When the printing device transmits a print request and the key assigned to the printing device, to the print server device, the print server device which has received the print request transmits to the printing device the part of electronic data corresponding to the transmitted key, and the printing device receives and outputs the part of electronic data.

Assuming that the electronic data is of distribution materials and a printing device is one provided in respective shops, a person in charge of distribution need not compile or process the distribution materials, but only specifies a part of the distribution materials which is permitted to be printed by the printing device of each of the shops and specify a printing device permitted to print the specified part of the distribution materials. Therefore, the task of the person in charge of distribution is simplified. In addition, only a part of the distribution materials permitted to be printed by a printing device is transmitted to the printing device. Therefore, it is not necessary to disclose all the distribution materials.

Further, in the invention, it is preferable that the client device sets up one or a plurality of keys per part of the generated electric data.

Further, according to the invention, the client device sets up one or a plurality of keys per part of the generated electronic data.

By doing so, it is possible to simply and flexibly specify electric data permitted to be printed.

Further, in the invention, it is preferable that the key assigned to the printing device is an MAC address set for a data communicating device which the printing device has.

Further, according to the invention, as the key assigned to the printing device, it is possible to use an MAC address set for a data communicating device which the printing device has.

Further, in the invention, it is preferable that the key assigned to the printing device is an IP address assigned to the printing device.

Further, according to the invention, as the key assigned to the printing device, it is possible to use an IP address assigned to the printing device.

Further, in the invention, it is preferable that the key assigned to the printing device is any one of a pre-registered device name, a pre-registered telephone number of an installation site, and a pre-registered address of the installation site of the printing device.

Further, according to the invention, as the key assigned to the printing device, it is possible to use a pre-registered device name, a pre-registered telephone number of an installation site, or pre-registered address of the installation site of the printing device.

Further, the invention provides a printing method in which a print server device manages electronic data generated by a client device and a plurality of printing devices acquire and directly print the electronic data managed by the print server device, the printing method comprising:

specifying, by the client device, a printable part of the generated electronic data for each of a plurality of printing devices, preparing a correspondence table in which the printable part of the generated electronic data for each of the plurality of printing devices is correlated with a key for identifying a printing device which is permitted to print the printable part of the generated electronic data, and transmitting the generated electronic data and the correspondence table to the print server device,

receiving and managing, by the print server device, the electronic data and the correspondence table transmitted from the client device,

transmitting, by the printing device, a print request and the key assigned to the printing device, to the print server device, and

upon receiving the print request, transmitting to the printing device the part of electronic data corresponding to the transmitted key by the print server device, and acquiring and outputting the part of electronic data by the printing device.

Further, according to the invention, there are provided a printing method in which a print server device manages electronic data generated by a client device and a plurality of printing devices acquire and directly print the electronic data managed by the print server device.

Firstly, in the client device, a printable part of the generated electronic data is specified for each of a plurality of printing devices, a correspondence table is prepared in which the printable part of the generated electronic data for each of the plurality of printing devices is correlated with a key for identifying a printing device which is permitted to print the printable part of the generated electronic data, and the generated electronic data and the correspondence table is transmitted to the print server device.

In the print server device, the electronic data and the correspondence table transmitted from the client device are stored and managed.

When the printing device transmits a print request and the key assigned to the printing device, to the print server device, the print server device which has upon received the print request transmits to the printing device the part of electronic data corresponding to the transmitted key, and the printing device acquires and outputs the part of electronic data.

Assuming that the electronic data is of distribution materials and a printing device is one provided in each of the shops, the person in charge of distribution needs not compile or process the distribution materials, but only specifies a printing device permitted to print the specified part of the distribution materials. Therefore, the task of the person in charge of distribution is simplified. In addition, only a part of the distribution materials permitted to be printed by a printing device is transmitted to the printing device. Therefore, it is not necessary to disclose all the distribution materials.

### BRIEF DESCRIPTION OF THE DRAWINGS

Other and further objects, features, and advantages of the invention will be more explicit from the following detailed description taken with reference to the drawings wherein:

FIG. 1 is a view schematically showing a printing system according to one embodiment of the invention;

FIG. 2 is a block diagram illustrating a hardware configuration of the printing system;

FIG. 3 is a view showing a list of IDs of digital multifunction printers permitted to execute printing;

FIG. 4 is a view showing a correspondence table between print object and printing permission list;

FIG. 5 is a view showing a list of digital multifunction printer ID transmitted from an MFP;

FIG. 6 is a flowchart showing operations of a client PC;

FIG. 7 is a flowchart showing operations of a print server and the MFP;

FIG. 8 is a view showing a selection screen of applications;

FIG. 9 is a view showing a selection screen of objects; and

FIG. 10 is a view showing a screen representing nonexistence of object permitted to be printed.

### DETAILED DESCRIPTION

Now referring to the drawings, preferred embodiments of the invention are described below.

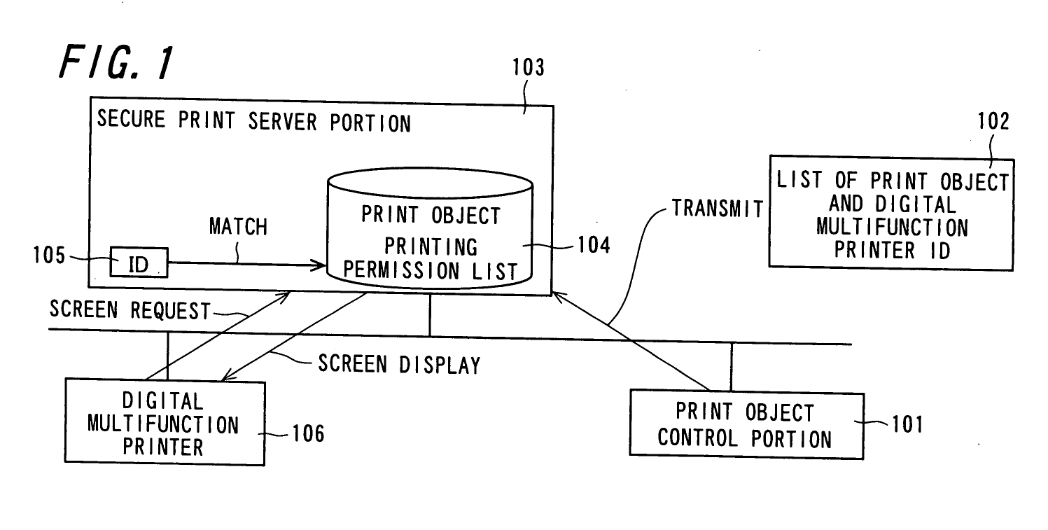

FIG. 1 is a view schematically showing a printing system according to one embodiment of the invention.

The printing system is configured of a print object control portion 101, a secure print server portion 103, and a digital multifunction printer 106 which are so disposed that data is allowed to be communicated thereamong.

The print object control portion 101 creates a list 102 of print object and digital multifunction printer ID and transits the list 102 thus created to the secure print server portion 103.

The secure print server portion 103 receives the list 102 of print object and digital multifunction printer ID from the print object control portion 101. The received list 102 of print object and digital multifunction printer ID is brought by the secure print server portion 103 into a storage portion 104 as a printing permission list with a correspondence relationship established between the print object and the digital multifunction printer ID. Further, the secure print server portion 103 compares an ID 105 transmitted from the digital multifunction printer 106 and the printing permission list.

The digital multifunction printer 106 accepts a print request and transmits the digital multifunction printer ID to the secure print server portion 103.

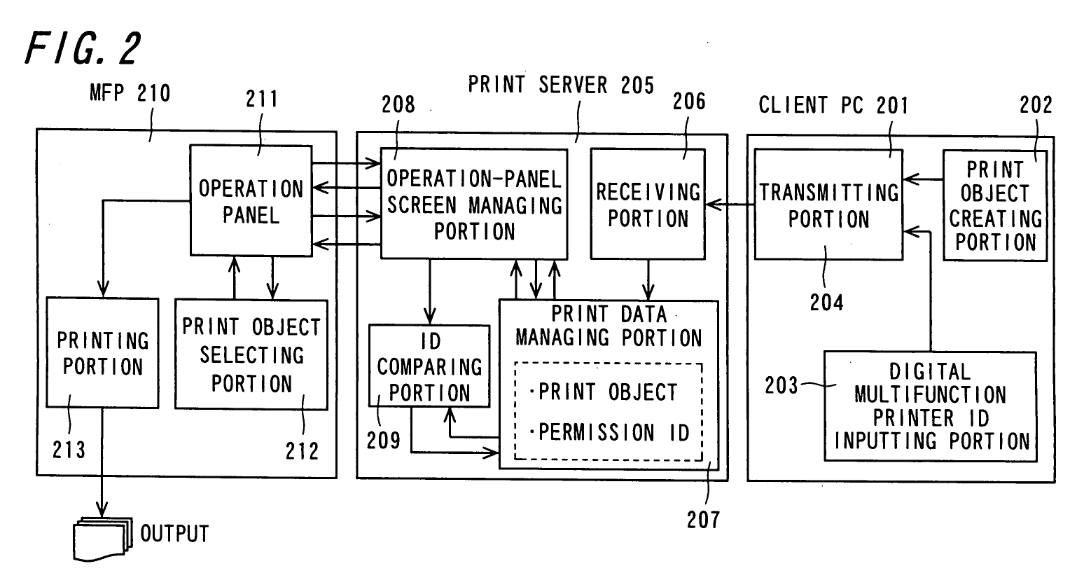

FIG. 2 is a block diagram illustrating a hardware configuration of a printing system.

The printing system is configured of a client PC (a personal computer) 201, a print server 205, and an MFP (multifunction printer) 210.

The client PC 201 includes a print object creating portion 202, a digital multifunction printer ID inputting portion 203, a transmitting portion 204. The client PC 201 corresponds to the print object control portion 101 shown in FIG. 1.

The print object creating portion 202 creates a print object by using application programs or so forth. The digital multifunction printer ID inputting portion 203 inputs an ID of MFP, which is the digital multifunction printer, permitted to print the print object created by the print object creating portion 202. The transmitting portion 204 transmits the print object and the digital multifunction printer ID to the print server 205.

The digital multifunction printer ID is a key for allowing the MFP 210 to be discriminated from other devices. The print object refers to one of plural parts constituting electronic data which is of a series of printable distribution materials such as image data for presentation, image data for advertisement, and text data for in-company meetings. That is, the print object refers to, for example, one page of the series of distribution materials, etc.

The print server 205 includes a receiving portion 206, a print data managing portion 207, an operation-panel screen managing portion 208, and an ID comparing portion 209. The print server 205 corresponds to the secure print server portion 103 shown in FIG. 1.

The receiving portion 206 receives data transmitted from the transmitting portion 204 of the client PC 201, such as the print object and the digital multifunction printer ID. The print data managing portion 207 is used for storing and managing the data received by the receiving portion 206, and corresponds to the storage portion 104 shown in FIG. 1.

The operation-panel screen managing portion 208 has a function of receiving the ID of the MFP 210 transmitted from the MFP 210, and a function of generating image data to be displayed on an operation panel of the MFP 210. The ID comparing portion 209 compares the ID of the MFP 210 received by the operation-panel screen managing portion 208 and the digital multifunction printer ID stored in the print data managing portion 207.

The MFP 210 includes an operation panel 211, a print object selecting portion 212, and a printing portion 213.

The operation panel 211 has a function of accepting a screen request and a print request of the MFP 210 and transmitting the ID of the MFP 210 to the print server 205, and a function of displaying data received from the operation-panel screen managing portion 208. The print object selecting portion 212 selects an intended print object. The printing portion 213 prints the print object.

Hereinbelow, an operation of the printing system will be described in detail.

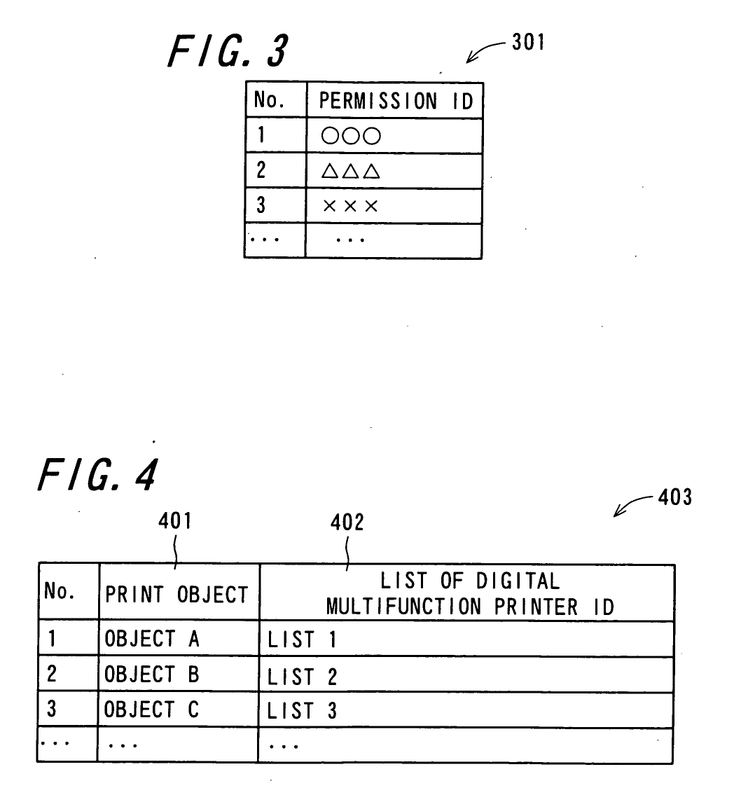

FIG. 3 is a view showing a list 301 of ID of digital multifunction printer permitted to execute printing. The list 301 is obtained by listing the digital multifunction printer IDs inputted from the digital multifunction printer ID inputting portion 203 of the client PC 201. From the client PC 201, a person in charge of material distribution inputs, out of MFPs 210 provided at shops, an ID of digital multifunction printer permitted to print a predetermined print object. The list 301 is created for each print object.

FIG. 4 is a view showing a correspondence table 403 between print object and printing permission list. The correspondence table 403 is a table in which correspondence relationships are established between lists 402 of the inputted printing permission IDs and objects 401 created by the print object creating portion 202 of the client PC 201. The person in charge of material distribution inputs the correspondence relationships. The correspondence table 403 is stored in the print data managing portion 207.

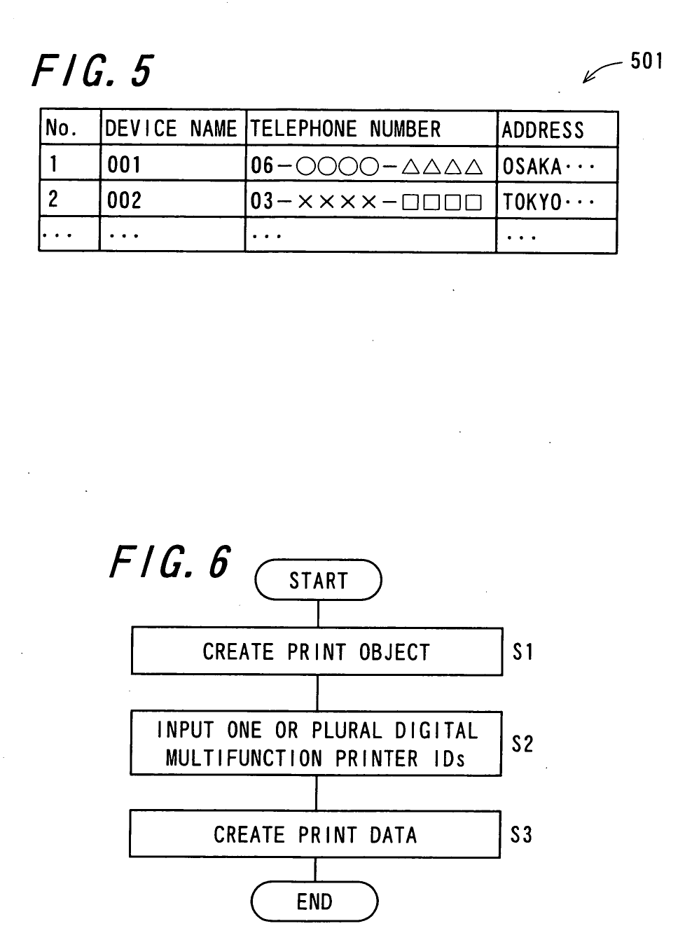

FIG. 5 is a view showing a list 501 of digital multifunction printer ID transmitted from the MFP 210. The digital multi0-function printer IDs transmitted from the MFP 210 are received by the operation-panel screen managing portion 208 and compiled in the list 501.

The digital multifunction printer ID refers to an MAC (Media Access Control) address assigned to an NIC (Network Interface Card) that is provided in the MFP 210; an IP (Internet Protocol) address assigned to the MFP 210; or information registered in the MFP 210 and allowing the MFP 210 to be discriminated from other MFPs 210. As the information allowing the MFP 210 to be discriminated from other MFPs 210, usable is any pre-registered one of a device name, a telephone number of an installation site, and an address of the installation site. In the example shown in FIG. 5, the telephone number and the address of installation site of the MFP 210 are used.

FIG. 6 is a flowchart showing operations of the client PC 201.

In Step S1, the print object creating portion 202 creates a print object, i.e. the distribution material.

In Step S2, the digital multifunction printer ID inputting portion 203 inputs an ID of digital multifunction printer permitted to print the created print object. By doing so, the list 301 shown in FIG. 3 and the correspondence table 403 are created.

In Step S3, the transmitting portion 204 transmits print data composed of the print object and the correspondence table, to the print server 205.

The print server 205 receives the print data from the client PC 201 and extracts the correspondence table 403 from the print data. Under the control of the print server 205, the extracted correspondence table 403 is stored into the print data managing portion 207.

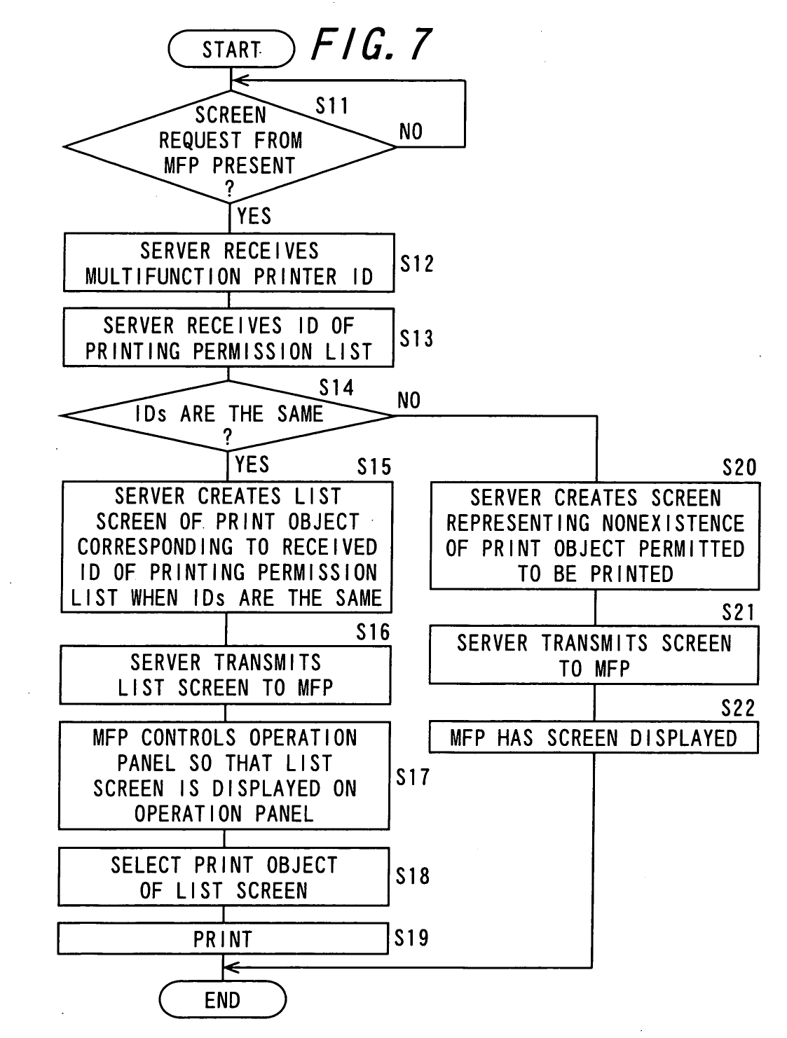

FIG. 7 is a flowchart showing operations of the print server 205 and the MFP 210.

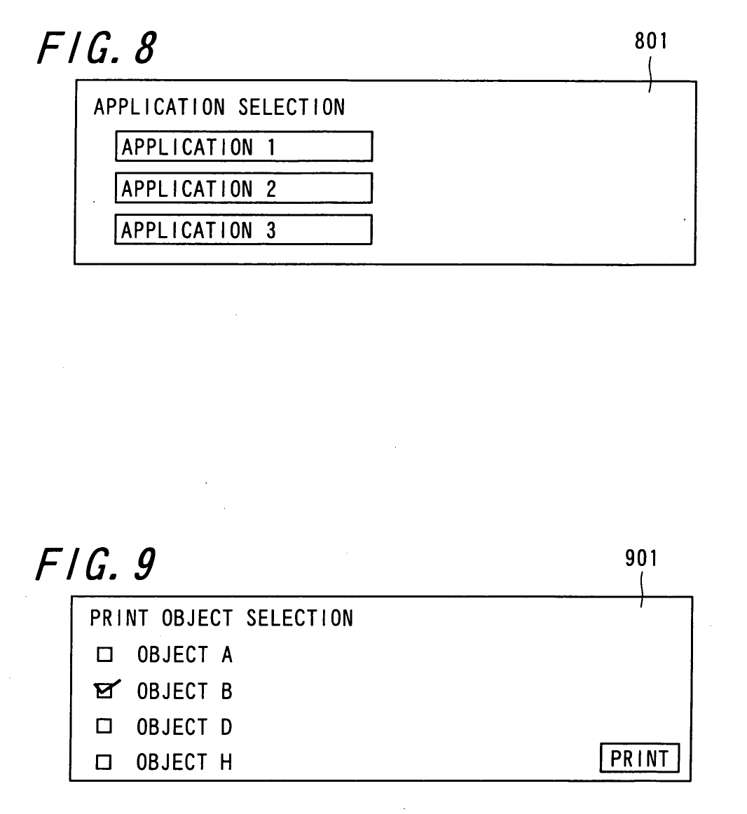

In Step 11, it is determined whether or not a screen request from the MFP 210 is present. When a screen request is present, the procedure proceeds to Step 12. On the other hand, when the screen request from the MFP 210 is absent, the print server keeps standing by. When a responsible person in each shop operates the operation panel 211 of the MFP 210 so that one of applications is selected from an application selection screen 801 as shown in FIG. 8, the screen request for the print object selection screen from the MFP 210 is made.

In Step S12, the operation-panel screen managing portion 208 retrieves the ID from the MFP 210 having made the screen request. In Step S13, the ID comparing portion 209 compares the retrieved ID of the MFP 210 and the ID of the MFP 210 in the correspondence table 403, in reference to the correspondence table 403 stored in the print data managing portion 207 (Step S14).

When the digital multifunction printer ID of the correspondence table 403 is the same as the retrieved ID of the MFP 210, the procedure proceeds to Step 15. On the other hand, when the digital multifunction printer ID of the correspondence table 403 is different from the retrieved ID of the MFP 210, the procedure proceeds to Step S20.

In Step S15, there is extracted an object corresponding to the digital multifunction printer ID which is the same as the ID of the MFP 210. Further, in Step S15, image data is generated which represent an object selection screen 901 as shown in FIG. 9.

In Step S16, the generated image data is transmitted to the MFP 210. In Step S17, the MFP 210 receives the image data transmitted from the print server 205 and controls a display portion of the operation panel 211 so that the image data is displayed on the display portion.

In Step S18, the responsible person selects an object that he/she wants to print. In Step S19, the selected object is printed by the printing portion 213.

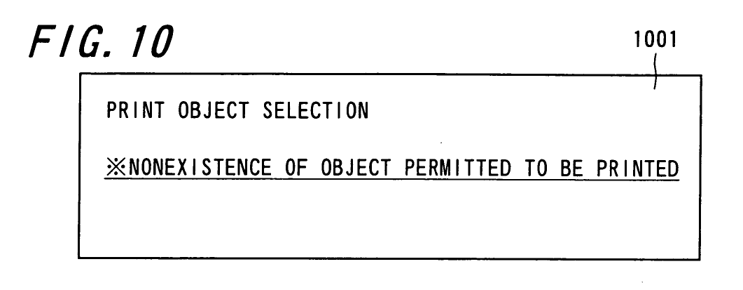

In Step S20, there is created image data of display screen representing nonexistence of an object permitted to be printed. In Step S21, the created image data is transmitted to the MFP 210. In Step S22, a screen 1001 representing nonexistence of the object permitted to be printed as shown in FIG. 10 is displayed on the display portion of the operation panel 211.

The invention may be embodied in other specific forms without departing from the spirit or essential features thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A printing system comprising:
a client device for generating electronic data;
a print server device for managing the electronic data generated by the client device; and
a plurality of printing devices for acquiring and directly printing the electronic data managed by the print server device, data communication being allowed thereamong,
the client device specifying a printable part of the generated electronic data for each of the plurality of printing devices, preparing a correspondence table in which the printable part of the generated electronic data for each of the plurality of printing devices is correlated with a key for identifying a printing device which is permitted to print the printable part of the generated electronic data, and transmitting the generated electronic data and the correspondence table to the print server device,
the print server device receiving and managing the electronic data and the correspondence table transmitted from the client device,
the printing device transmitting a print request and the key assigned to the printing device, to the print server device, and
upon receiving the print request, the print server device transmitting to the printing device the part of electronic data corresponding to the transmitted key, and the printing device acquiring and outputting the part of electronic data.

2. The printing system of claim 1, wherein the client device sets up one or a plurality of keys per part of the generated electric data.

3. The printing system of claim 1, wherein the key assigned to the printing device is an MAC address set for a data communicating device which the printing device has.

4. The printing system of claim 1, wherein the key assigned to the printing device is an IP address assigned to the printing device.

5. The printing system of claim 1, wherein the key assigned to the printing device is any one of a pre-registered device name, a pre-registered telephone number of an installation site, and a pre-registered address of the installation site of the printing device.

6. A printing method in which a print server device manages electronic data generated by a client device and a plurality of printing devices acquire and directly print the electronic data managed by the print server device, the printing method comprising:
specifying, by the client device, a printable part of the generated electronic data for each of a plurality of printing devices, preparing a correspondence table in which the printable part of the generated electronic data for each of the plurality of printing devices is correlated with a key for identifying a printing device which is permitted to print the printable part of the generated electronic data, and transmitting the generated electronic data and the correspondence table to the print server device,
receiving and managing, by the print server device, the electronic data and the correspondence table transmitted from the client device,
transmitting, by the printing device, a print request and the key assigned to the printing device, to the print server device, and
upon receiving the print request, transmitting to the printing device the part of electronic data corresponding to the transmitted key by the print server device, and acquiring and outputting the part of electronic data by the printing device.
